(19) United States
(12) Patent Application Publication
(10) Pub. No.: US 2008/0105232 A1
(43) Pub. Date: May 8, 2008

(54) Method for switching the modes of operation for an internal combustion engine

(76) Inventors: Thomas Boehme, Wesendorf (DE); Stefan Linka, Gifhorn (DE); Olaf Magnor, Braunschweig (DE); Michael Schnaubelt, Gifhorn (DE); Matthias Schultalbers, Meinersen (DE)

Correspondence Address: COLLARD & ROE, P.C., 1077 NORTHERN BOULEVARD, ROSLYN, NY, 11576, US

(21) Appl. No.: 11/983,314

(22) Filed: Nov. 8, 2007

(30) Foreign Application Priority Data
Nov. 8, 2006 (DE) 10 2006 053 254.6

(51) Int. Cl. F02B 17/00

(52) U.S. Cl. 123/295

(57) ABSTRACT

A method for switching the modes of operation of an internal combustion engine switches between a method of homogeneous compression ignition and a conventional combustion method. The operating ranges of the modes of operation are defined at least by way of speed of rotation and load, and a switch between the operating ranges takes place as a function of the current operating point and of quantifiable characteristics of the trajectory as well as of the distance of the current operating point from the range limit of the operating range. Characteristics of the trajectory are the current movement direction and/or the speed of approach of the operating point to the range limit.

### CROSS REFERENCE TO RELATED APPLICATIONS

This application claims priority under 35 U.S.C. §119 of German Patent Application No. DE 10 2006 053 254.6 filed on Nov. 8, 2006.

### BACKGROUND OF THE INVENTION

1. Field of the Invention

The invention relates to a method for switching the modes of operation of an internal combustion engine, in which a switch is made between a method of homogeneous compression ignition and a conventional combustion method.

2. The Prior Art

Combustion methods are generally known in which a homogeneously pre-mixed fuel/air mixture is ignited by auto ignition. These combustion methods are frequently referred to as HCCI (homogeneous charge compression ignition) or CAI (controlled auto ignition). In order to achieve homogeneous combustion, a sufficiently high energy level must be present in the cylinder. This can be brought about, for example, by a high compression pressure and/or by a sufficient amount of hot residual gas. Control of the parameters that influence auto ignition, such as compression, exhaust gas reflux rate, injection time, fuel distribution, air filling, etc., is very complex. For example, a method for controlling the combustion sequence, in which an HCCI combustion process is modeled by internal status variables, and the output variables of the modeled combustion process are used to regulate the setting variables that influence the auto ignition is described in German Patent No. DE 102 37 328 B4. In this connection, setting variables can be the control of inlet and outlet valves of the internal combustion engine, for example, which can be variably controlled with regard to their stroke and their on time. Both the compression and the exhaust gas reflux rate, in the case of internal exhaust gas reflux, can be influenced by variable on times. Additional influence parameters can be the setting of an exhaust gas reflux valve, an adjustable compression ratio, or the injection parameters. In this connection, the operating mode of homogeneous auto ignition cannot be represented in all operating points, but rather are mostly limited to the range of partial load. It is difficult to manage the process, particularly in the marginal ranges and at dynamic operating transitions. Until now, the combustion method has been used practically only in limited characteristic field ranges at almost stationary operation. In broad operating ranges, the internal combustion engine is operated in a conventional manner. Here, the switching strategy has particular significance, in order to expand the characteristic field ranges in which homogeneous auto ignition can be used.

German Patent No. DE 101 61 551 B4 describes representing ranges of homogeneous auto ignition and conventional combustion in a characteristic field by way of the speed of rotation and the effective average pressure as a load equivalent, and describes establishing auto ignition and outside ignition ranges on the basis of these variables. In this connection, the ranges are defined for static operating points.

Homogeneous compression ignition is used in operation both with gasoline and with diesel fuel. It refers to a combustion method in which an exothermic reaction of the fuel/air mixture takes place at the same time at all points in the combustion chamber. For operation with gasoline, the designation CAI, among others, is often used for operation with homogeneous compression ignition. Homogeneous compression ignition methods for diesel fuel are usually referred to as HCCI. The previously known so-called conventional combustion methods differ in terms of the combustion of the fuel/air mixture. With conventional combustion methods, spreading of a flame front occurs, or, as known from the diesel engine, diffusion combustion with injection into a fuel/air mixture that is already burning takes place. For gasoline, the conventional combustion methods require outside ignition, in addition to this differentiation according to the type of combustion.

### SUMMARY OF THE INVENTION

It is therefore an object of the invention to provide a switching strategy between homogeneous compression ignition combustion and a conventional combustion method, which takes advantage of the characteristic field ranges of homogeneous combustion, particularly in the dynamic range, and, at the same time, limits the switching frequency.

This task is accomplished by a method for switching the modes of operation of an internal combustion engine between a mode of operation of homogeneous compression-ignited combustion and a mode of operation of conventional combustion. The operating ranges of the modes of operation can be defined at least by speed of rotation and load. A switch between the operating ranges takes place as a function of the current operating point and of quantifiable characteristics of the trajectory as well as of the distance of the current operating point from the range limit of the operating range.

Switching of the mode of operation takes place between a combustion method of homogeneous, compression-ignited combustion, and an operating mode of conventional combustion, so that each of the operating ranges are defined by way of the characteristic variables of speed of rotation and load. It is advantageous that switching between the operating ranges takes place as a function of the current operating point and of quantifiable characteristics of the track curve, as well as the distance of the current operating point from the range limit of the operating range. As a result, switching is not carried out rigidly at the range limit, but rather adapted to the dynamic operation of the internal combustion engine in the vehicle. The switching time point is defined on the basis of the characteristics of the track curve in the speed of rotation/load characteristic field and the current distance from the range limit.

The characteristics of the track curve of the operating state are evident from the history of the movement of the operating point. The current movement direction and/or the speed of approach of the operating point to the range limit are determined. Additional characteristics can be the shortest distance from the range limit or the intersection of the track curve with the range limit. The dynamic progression of the operating point is thereby assessed with regard to its approach to the new operating range, and switching, i.e. setting of the switching conditions, can take place in prospective manner. With regard to the time coordination of the switching processes, the movement direction and the movement speed of the current operating point, in particular, are advantageous characteristics. An intersection with the operating range can be predicted from the track curve, and the time when it will occur can be predicted from the movement speed, and thus the start of the switch in operating mode can be predicted.

According to the invention, switching to a new operating range can depend on a predicted dwell time in the new operating range. A dwell time in the new operating range, measured in accordance with the method limits, is predicted on the basis of the track curve parameters. If the operating range is only touched, and if only “touching” of the new operating range occurs, due to its expanse in the speed of rotation/load characteristic field, in other words passage through the field with a short dwell time, switching to the new range will not take place. In this connection, the minimal dwell time is a parameter that can be applied, and this time lies above a time required for switching that is torque-neutral.

In an advantageous embodiment of the invention, a switch from the operating mode of homogeneous compression ignition to a conventional mode of operation takes place directly at the limit of the operating range, since the torque-neutral switch takes place almost keeping step, in terms of time. For the switch to the range of homogeneous compression ignition, synchronization of the throttle valve and the ignition angle is necessary for a torque-neutral switch, and a time delay occurs due to the gas running times. In this connection, initialization of the switch in mode of operation to the operating range of homogeneous compression ignition takes place before the range limit is reached. The parameters of dwell time and the distance from the operating range as well as the approach speed are utilized for determining the switching point. Implementation of the switch at the range limit can be assured by predicting the switching time point, thereby making effective utilization of the range of homogeneous compression ignition possible, with advantageous fuel consumption and the resulting exhaust gases.

### BRIEF DESCRIPTION OF THE DRAWING

Other objects and features of the present invention will become apparent from the following detailed description considered in connection with the accompanying drawing. It is to be understood, however, that the drawing is designed as an illustration only and not as a definition of the limits of the invention.

FIG. 1 shows a diagram in which the effective average pressure Pₑ is plotted over the speed of rotation n.

### DETAILED DESCRIPTION OF THE PREFERRED EMBODIMENT

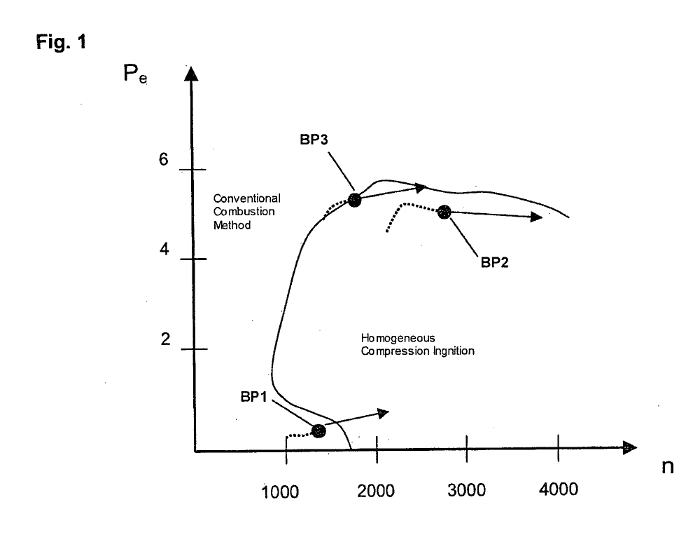

Referring now in detail to the drawing, FIG. 1 shows a diagram in which the effective average pressure Pₑ is plotted over the speed of rotation n. The solid line refers to the range limit within which the internal combustion engine can be operated with homogeneous compression ignition. Outside of the range limit, the internal combustion engine is operated with a conventional combustion method, e.g. when using gasoline, with a shift loading method and outside ignition. Here, the range limit is shown as an example. It can be determined by test bench results. The range of homogeneous compression ignition is particularly limited in the range of low speeds of rotation and at high loads. In dynamic operation of the internal combustion engine, the range in which a homogeneous, compression-ignited combustion method can be used is passed through again and again. It is therefore tremendously important for utilization of the characteristic field range to pursue a suitable switching strategy. According to the invention, a switch request takes place on the basis of the evaluation of the current operating point BP and its distance from the range limit. Here, characteristics of the track curve of the operating point over the past few combustion cycles that have elapsed—shown with a broken line—are taken into consideration for the evaluation. A current direction of the movement of the operating point as well as its movement speed can be predicted from the progression of the track curve.

The method is illustrated using three operating points shown as examples. BP1 shows an example for a switch into the operating range of homogeneous compression ignition. Proceeding from the current position of the operating point in the characteristic field, its movement direction and the current distance from the range limit are assessed. The absolute distance of the operating point from the range limit as well as the distance from the intersection with the range limit serve as measures for the assessment. Entry into the range of homogeneous compression ignition can be predicted on the basis of the current movement speed of the operating point in the characteristic field, and the switch can be predicted and prepared for using the entry time. The release of operation with homogeneous compression ignition furthermore depends on whether the requested torque demand can be implemented in the mode of operation. If there is a release of operation with homogeneous compression ignition, a complex control of the inflowing gas masses, of the ignition angle, and of the injection is necessary, in order to make a torque-neutral switch into the operating range of homogeneous auto ignition possible. If, for example, a cam shaft that can be switched with regard to its stroke is used to control the gas alternating valves, which shaft has an additional stroke for the outlet valve in the intake phase, for residual gas control, first greater opening of the throttle valve takes place for a torque-neutral switch, and the torque build-up in the conventional mode of operation is limited by decreasing the ignition angle. Unthrottling can take place at the switch of the cam lift curves, and the lamda value is adjusted to a lamda value that is advantageous for homogeneous compression ignition operation between about 1.1 and about 1.4, by means of the fuel injection.

The ignition can be set to extremely early values, so that the mixture is not ignited, but rather an energy enrichment takes place, which can slightly influence the time point of auto ignition of the mixture in the cylinder. In this connection, switching requires a defined time period, because of the gas running times for torque-neutral switching, so that a switch can take place ahead of the range limit, on the basis of knowledge of the track curve. This time point is predictable from the movement direction and the movement speed of the operating point in the characteristic field. In contrast, when the switch back out of the range of homogeneous auto ignition takes place, switching can take place directly at the range limit, since as the first thing, the necessary intervention by way of the quick paths, such as injection and ignition angle, takes place, and the torque that comes from the range of homogeneous compression ignition can be represented with the conventional combustion method. Here, however, it must be assured that premature switching does not take place, so that a frequent change in mode of operation at the range limits is avoided. Here, the operating point BP2 shows staying in the range of homogeneous compression ignition, as an example.

Since a tendency to remain in the range of homogeneous compression ignition can be derived from the track curve, no switching takes place, even though the operating point lies close to the range limit. This observation should also be considered as an example only for the reverse case of origin from the conventional combustion method.

Operating point BP3 shows an example in which the operating range of homogeneous compression ignition is merely touched. On the basis of the characteristics of the track curve, it can be estimated that the region of homogeneous compression ignition will only be touched. On the basis of the movement speed and the direction of the movement, a dwell time in the range of homogeneous compression ignition can be estimated, so that no switching takes place in the case of a low dwell time. If the predicted movement direction of the operating point changes, in other words if its movement slows down, or if the movement direction turns into the range of homogeneous compression ignition, the estimated dwell time is lengthened and a switch into the range of homogeneous compression ignition takes place.

Accordingly, while only a few embodiments of the present invention have been shown and described, it is obvious that many changes and modifications may be made thereunto without departing from the spirit and scope of the invention.

What is claimed is:

1. A method for switching the modes of operation of an internal combustion engine between homogeneous compression-ignited combustion and conventional combustion, wherein operating ranges of the modes of operation are defined at least by way of speed of rotation and load, wherein the switching between the modes of operation takes place as a function of a current operating point and of quantifiable characteristics of a trajectory as well as of a distance of the current operating point from a range limit of the operating range.

2. A method according to claim 1, wherein the characteristics of the trajectory are the current movement direction or speed of approach of the operating point to the range limit.

3. A method according to claim 1, wherein departure from the current operating range or entry into a new operating range, respectively, is predicted on the basis of movement direction and movement speed of the current operating point regarding its occurrence in terms of time.

4. A method according to claim 1, wherein a switch to a new operating range depends on a predicted dwell time in the operating range.

5. A method according to claim 1, wherein when a switch back out of homogeneous combustion takes place, the switch takes place directly at a limit of the operating range.

6. A method according to claim 1, wherein when there is a switch in mode of operation, switching takes place before the operating range of homogeneous combustion has been reached, and the parameters of dwell time and distance from the operating range as well as approach speed are utilized to determine a switching point.

7. A method according to claim 4, wherein when an operating range limit is reached, a switch to the operating range of homogeneous combustion does not take place if the predicted dwell time is less than a limit value that can be determined, said limit value being greater than a time period required for torque-neutral switching.
